(19) United States
(12) Patent Application Publication
(10) Pub. No.: US 2026/0180610 A1
(43) Pub. Date: Jun. 25, 2026

(54) Circuits and Methods Providing a Signal Path with an Adjustable Attenuator

(71) Applicant: TEXAS INSTRUMENTS INCORPORATED, Dallas, TX (US)

(72) Inventors: Radhika Juluri, Bangalore (IN); Ashlesha Yerramsetty, Hyderabad (IN); Debapriya Sahu, Bangalore (IN); Prakhar Agrawal, Bangalore (IN); Srinivas Veeramreddi, Bengaluru (IN); Meghna Agrawal, Bengaluru (IN)

(21) Appl. No.: 19/071,699

(22) Filed: Mar. 5, 2025

(30) Foreign Application Priority Data
Dec. 20, 2024 (IN) 202441101245

(51) Int. Cl. H04B 1/40; H04B 1/00

(52) U.S. Cl. CPC H04B 1/40; H04B 1/0078

(57) ABSTRACT

A system includes a transceiver having at least one receive signal chain and at least one transmit signal chain. The receive signal chain may include an adjustable capacitive attenuator. An automatic gain control circuit may be configured to make measurements of gain in the receive signal chain and to adjust an amount of gain by adjusting attenuation at the adjustable capacitive attenuator.

### CROSS-REFERENCE TO RELATED APPLICATIONS

The present application claims the benefit of Indian Provisional Patent Application 202441101245, filed Dec. 20, 2024, the disclosure of which is hereby incorporated by reference in its entirety.

### TECHNICAL FIELD

The present application relates to an electronic circuit and method, and in particular embodiments, to circuits and methods providing a signal path with an adjustable attenuator.

### BACKGROUND

Radio frequency (RF) transceivers are used in a variety of devices that rely on wireless communications. These RF transceivers may operate at a variety of frequencies based on their applications. For example, cellular telephones, Wi-Fi devices, Bluetooth devices, and the like, operate at a variety of frequencies and may employ an RF transceiver to receive signals over the air.

### SUMMARY

In accordance to an embodiment, an electronic circuit includes: a first signal path including: a first current mode mixer having first and second inputs, and first and second outputs; a first amplifier circuit having first and second inputs respectively coupled to the first and second outputs of the first current mode mixer; and a first adjustable capacitive attenuator circuit having first and second outputs respectively coupled to the first and second inputs of the first current mode mixer; and a second signal path including: a second current mode mixer having first and second inputs, and first and second outputs; a second amplifier circuit having first and second inputs respectively coupled to the first and second outputs of the second current mode mixer; and a second adjustable capacitive attenuator circuit having first and second outputs respectively coupled to the first and second inputs of the second current mode mixer.

In accordance to an embodiment, an electronic circuit includes: an antenna terminal; a low noise trans-impedance amplifier (LNTA) having an input coupled to the antenna terminal, and first and second outputs; a current mode mixer having first and second inputs; and an adjustable capacitive attenuator having a first terminal coupled to the first output of the LNTA and to the first input of the current mode mixer, and a second terminal coupled to the second output of the LNTA and to the second input of the current mode mixer.

In accordance to an embodiment, a method includes: operating a receive signal chain at a first gain level, where the receive signal chain includes a capacitive attenuator having first and second terminals respectively coupled to first and second inputs of a current mode mixer; adjusting a gain setting of the receive signal chain to a second gain level without adjusting a capacitance of the capacitive attenuator, where the second gain level is lower than the first gain level; measuring a signal at the second gain level; and in response to measuring the signal, adjusting the gain setting to a third gain level, which is lower than the second gain level, including adjusting the capacitance of the capacitive attenuator to achieve the third gain level, the third gain level being lower than the second gain level.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example system, according to some embodiments;

FIG. 2 is an illustration of an example system, for receiving wireless signals, according to some embodiments; and

FIG. 3 is an illustration of an example system, for receiving wireless signals, according to some embodiments;

FIG. 4 is an illustration of example analog-to-digital converter (ADC) resources, which may be used in receivers, according to some embodiments;

FIG. 5 is an illustration of an example adjustable capacitive attenuator circuit architecture, according to some embodiments;

FIG. 6 is an illustration of an example receive AGC circuit, according to some embodiments;

FIG. 7 is an illustration of an example configuration for operation of a receive AGC circuit, according to some embodiments; and

FIG. 8 is an illustration of an example method, for adjusting a gain in a circuit, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

A receiver of a communication device, such as a wireless transceiver, may include a set of signal processing stages arranged in a receive signal chain. These stages may include one or more amplifier stages. To improve reception of weaker signals, the combined gain of the amplifier stages may be relatively high. However, applying large gains to stronger signals may saturate the amplified signal, leading to distortion (e.g., clipping) in the amplified signal that may make extracting data from the signal more difficult. In extreme cases, the data may be lost entirely. Accordingly, some receivers use automatic gain control (AGC) mechanism to dynamically control the gain based on the signal strength.

Some embodiments may employ an AGC algorithm that uses a set order to reduce gain among the devices of the receive signal chain. For instance, an example AGC algorithm may reduce a gain of an amplifier that is most downstream in the receive chain, and if reducing the gain of that amplifier to an operational minimum is not enough to avoid saturation, then the AGC algorithm may move to the next most upstream component, reducing the gain, and repeating the process if necessary.

Some embodiments include an adjustable attenuator, which may be implemented in a receive signal chain between an amplifier circuit and a mixer. The attenuator may be adjusted to provide more or less attenuation, where more attenuation corresponds to reducing gain, and less attenuation corresponds to increasing gain. Thus, the attenuator in the receive signal path may provide another component at which gain of the signal path as a whole may be reduced to avoid saturation.

In one example, the adjustable attenuator may be implemented as a capacitive attenuator. For instance, a capacitive attenuator may have multiple legs, each of the legs having at least one capacitor as well as a transistor that may be controlled by an AGC circuit. The legs may be arranged in parallel between the differential output terminals of an amplifier circuit. The capacitive attenuator may cause attenuation by reducing an amount of current traversing the differential output terminals from the amplifier circuit to a mixer. In one example, when more legs of the capacitive attenuator are controlled to be on, that may decrease capacitance and increase attenuation (reduce gain) and when fewer legs of the capacitive attenuator are controlled to be on, that may increase capacitance and decrease attenuation (increase gain).

The AGC circuit may measure a signal level at a downstream component (e.g., an analog-to-digital converter, ADC) and may increase or decrease a gain within the receive signal chain based upon that measurement. The AGC circuit may adjust the capacitive attenuator, where appropriate, to either increase or decrease the signal level at the downstream component. Furthermore, the capacitive attenuator may be used in a system that implements an input amplifier circuit as a low noise trans-impedance amplifier (LNTA) or implements a low noise amplifier (LNA) separately from a trans-impedance amplifier (TA).

Various embodiments may provide advantages. For instance, some embodiments may implement the adjustable capacitive attenuator between an input amplifier circuit and a mixer, so that it is upstream of the mixer and other components (e.g., intermediate frequency amplifier, variable gain amplifier, analog-to-digital converter). As a result, the upstream components may be advantageously designed for a smaller dynamic range because the gain may be reduced upstream of the mixer.

In another example, the adjustable capacitive attenuator may be implemented without resistors, so that the impedance of the adjustable capacitive attenuator may be almost entirely from the capacitance of the capacitors in the legs. This may advantageously allow for increasing attenuation steps without increasing resistance of the attenuator, thereby avoiding appreciable added noise. Therefore, the attenuator may be adjusted without negatively affecting a noise factor (NF) or signal-to-noise ratio (SNR).

In another example, some embodiments may implement the adjustable capacitive attenuator without appreciable increase in a size of the circuit. Thus, the advantageous functionality of the attenuator may be implemented without negatively impacting semiconductor area.

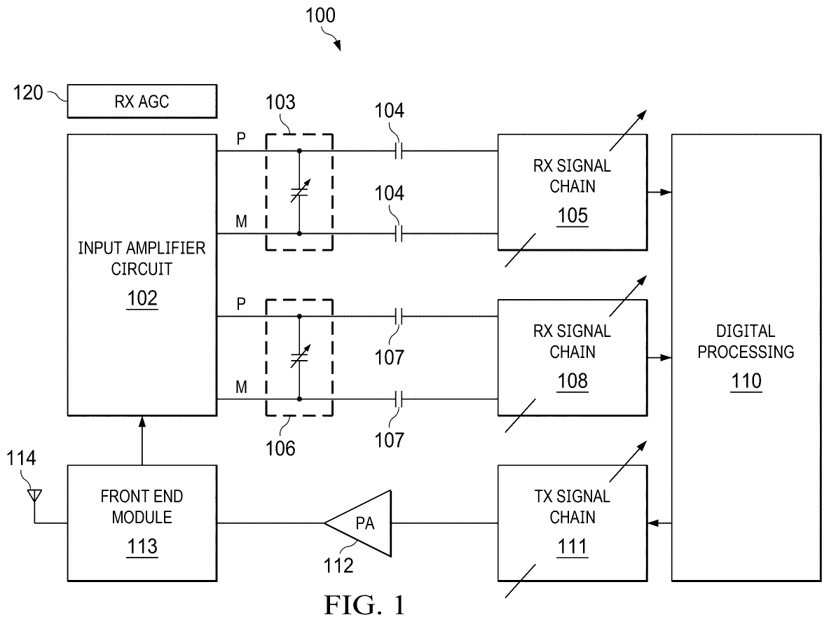

FIG. 1 is an illustration of an example system 100, according to some embodiments. In this example, system 100 may be implemented as a transceiver, which may be used for receiving and transmitting RF signals.

System 100 includes input amplifier circuit 102, which may include any appropriate input amplifier component. An example of an appropriate input amplifier component may be an LNTA or a combination of an LNA and one or more TAs. Input amplifier circuit 102 may receive RF signals from front-end module 113 and antenna 114. For instance, the receive signal chains 105, 108, may share the front-end module 113 and the antenna 114 with the transmit signal chain 111. The front end module 113 may include, e.g., filters and switches so that antenna 114 may be used for both transmitting and receiving over the air. For instance, the front end module 113 may include switches to perform a multiplexing function over time so that at some times antenna 114 is used for reception and other times antenna 114 is used for transmission. Front end module 113 may also include filters to remove unwanted signals. However, the scope of implementations is not limited to amplifier circuit 102 sharing antenna 114 with power amplifier 112. Rather, the scope of implementations may include power amplifier 112 having its own antenna or antenna array separate from an antenna or antenna array used for input amplifier circuit 102.

Input amplifier circuit 102 includes a set of differential outputs coupled to the RX signal chain 105 and RX signal chain 108 via attenuators 102 and 103, respectively. In this example, the positive (+) conductor of each differential output is labeled with P, and the negative (−) conductor of each differential output is labeled M.

In some embodiments, capacitive attenuator 103 is implemented in, or coupled to, RX signal chain 105, between the set of the differential outputs of the input amplifier circuit 102. Similarly, capacitive attenuator 106 may be implemented in, or coupled to, RX signal chain 108, between the set of the differential outputs of the input amplifier circuit 102. As explained in more detail with respect to FIG. 5, capacitive attenuator 103 may include multiple legs, each of the legs having one or more capacitors and one or more transistors. The receive automatic gain control (AGC) circuit 120 may apply control signals to each of the legs to increase or decrease capacitance, thereby affecting the attenuation provided by capacitive attenuator 103. The same may be true of capacitive attenuator 106.

In some embodiments, capacitive attenuator 103 is coupled to the receive signal chain 105 via a set of coupling capacitors 104. Similarly, capacitive attenuator 106 may be coupled to the receive signal chain 108 via a set of coupling capacitors 107. Each coupling capacitor has a first terminal coupled to the input amplifier circuit 102 and a second terminal coupled to its associated receive signal chain 105 or 108.

System 100 includes both receive signal chain 105 and receive signal chain 108. In one example, receive signal chain 105 is associated with an in-phase (I) signal, and receive signal chain 108 is associated with a quadrature-phase (Q) signal. Both of the RX signal chains 105 and 108 may include components that have adjustable gains. Examples of components in receive signal chains 105 and 108 may include mixers, filters, amplifiers, and/or other appropriate components. Thus, in some examples, each receive signal chain 105, 108 may include a mixer to reduce a frequency of the signal down to baseband or intermediate frequency, one or more filters and amplifiers to adjust a gain, and an analog-to-digital converter (ADC) circuit. At the output of each receive signal chain 105, 108, is a digital signal, which may be received by digital processing circuit 110. Examples of digital processing components may include one or more generic or custom processors or controllers coupled to a memory and configured to execute instructions in the memory, hardware accelerators, field programmable gate arrays (FPGAs), and other (e.g., digital) circuits, which allow for processing data and for controlling operation of system 100.

Transmit signal chain 111 is also coupled to digital processing circuit 110, and it may receive digital signals, which it may convert to analog signals to transmit as RF signals over antenna 114. For instance, the transmit signal chain 111 may include a digital-to-analog converter (DAC) circuit, amplifiers, filters, a mixer, and/or the like. One or multiple components within transmit signal chain 111 may include variable gain. Transmit signal chain 111 may provide an RF signal to the power amplifier 112. The power amplifier 112 may amplify the RF signal to an appropriate level for transmission over a wireless medium by antenna 114.

Receive AGC circuit 120 may control adjustable gain in any of the receive components, such as in the input amplifier circuit 102, attenuators 103, 106, and receive signal chains 105 and 108. An example AGC algorithm, such as may be implemented by receive AGC circuit 120, is described in more detail with respect to FIG. 7.

System 100 may be implemented on one or more chips. Each of the chips may be implemented using semiconductor dies in semiconductor packaging. In one example, the entirety of system 100 may be implemented on a single integrated circuit (IC) chip. In another example, some parts of system 100, such as antenna 114, may be either on a separate chip or not on a chip at all. In yet another example, system 100 may be implemented as part of a larger system on-chip, having other circuits, such as a modem, processor cores, and the like. In another example, all or part of the input amplifier circuit 102 may be implemented separate from a chip on which other parts of the system 100 are implemented (e.g., a low noise trans-impedance amplifier and antenna being implemented off-chip).

System 100 may be used in any appropriate application, such as in a Wi-Fi access point, a smart phone, tablet, or computer, a Bluetooth device, such as a Bluetooth low energy (BLE) device, an ultra-wideband (UWB) device, a radar device, a keyfob or card for access control, and/or the like.

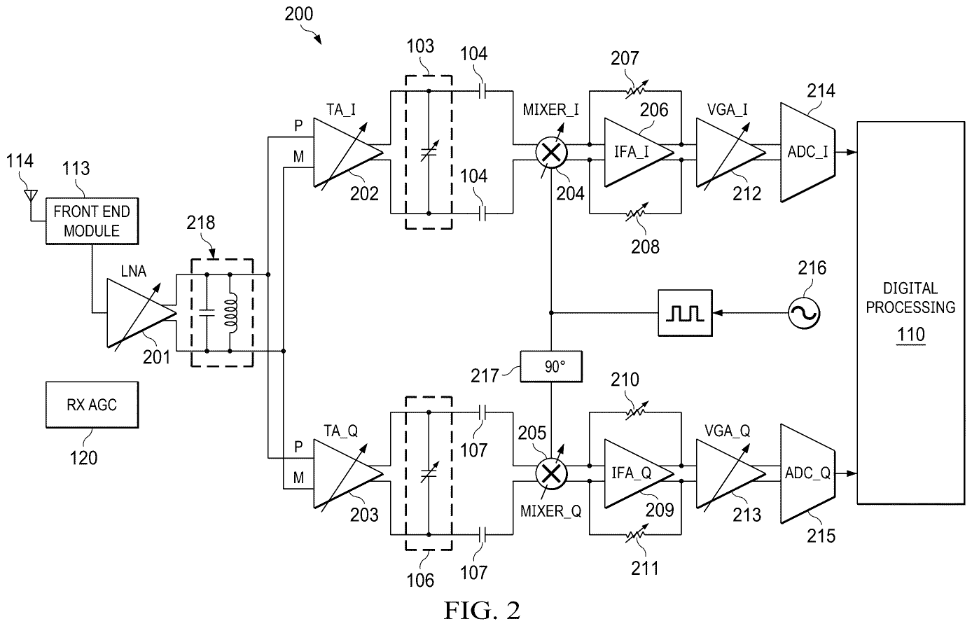

FIG. 2 is an illustration of an example system 200, for receiving wireless signals, according to some embodiments. For ease of illustration, a transmit signal chain has not been illustrated in FIG. 2, though it is understood that system 200 may be implemented with a transmit signal chain.

Example system 200 may be implemented according to the principles discussed above with respect to FIG. 1. For instance, LNA 201, TA 202, and TA 203 may correspond to the input amplifier circuit 102 of FIG. 1. Furthermore, mixer circuit 204, amplifiers 206 and 212, and ADC 214 may correspond to receive signal chain 105. Mixer 205, amplifiers 209 and 213, and ADC 215 may correspond to receive signal chain 108.

In some embodiments, LNA 201 is configured to receive RF signals over the air via antenna 114 and front end module 113. LNA 201 may provide some amount of gain to the RF signal and may convert the RF signal from single-ended to differential. LNA 201 has a differential output, which is split between the in-phase signal path (including mixer circuit 204) and the quadrature-phase signal path (including mixer circuit 205). LNA 201 may have a variable gain. Tank circuit 218 is implemented between the differential output conductors of the LNA 201, and tank circuit 218 may include at least a capacitor and an inductor. For instance, both of the capacitor and the inductor of tank circuit 218 may be implemented in parallel between the positive and negative output terminals of the LNA 201. Tank circuit 218 may be provided as a filter and for impedance matching. Further, in this example, tank circuit 218 is not adjustable and is implemented separately from adjustable capacitive attenuator circuits 103, 106.

The differential output of LNA 201 is split so that TA 202 is coupled to the positive and negative output terminals of LNA 201, as is TA 203. TA 202 provides adjustable gain, and it converts the voltage signal from the output of LNA 201 to a current mode signal. TA 202 includes a current mode differential output having a positive terminal and a negative terminal. TA 203 is implemented similarly in this example.

Adjustable capacitive attenuator circuit 103 is coupled between the positive and negative output terminals of TA 202, and coupling capacitors 104 are also coupled one each to the positive and negative output terminals of TA 202. Adjustable capacitive attenuator circuit 106 and coupling capacitors 107 are arranged similarly with respect to TA 203.

Mixer circuit 204 is coupled to the positive and negative output terminals of TA 202 via coupling capacitors 104 and adjustable capacitive attenuator circuit 103. Similarly, mixer circuit 205 is coupled to the positive and negative output terminals of TA 202 via coupling capacitors 107 and adjustable capacitive attenuator circuit 106.

Each of the mixer circuits 204, 205 is coupled to oscillator circuit 216 by a respective clock input. Oscillator circuit 216 may be implemented in any appropriate fashion, such as being implemented as a PLL or other appropriate circuit. The output of oscillator circuit 216 is split, so that the output of oscillator 216 that is received by mixer circuit 205 is phase-shifted 90° by phase shift circuit 217. By contrast, the output of oscillator 216 that is received by mixer circuit 204 is not phase-shifted. Thus, mixer circuit 204 is implemented as in-phase, and mixer circuit 205 is implemented as quadrature-phase. Each of mixer circuits 204 and 205 may include an adjustable gain. Furthermore, mixer circuits 204 and 205 may adjust a frequency of the RF signal down, such as from a gigahertz range to a megahertz range. However, the scope of implementations is not limited to any particular frequency range of operation. So 3.2 GHz and 2.4 GHz are given as examples, and the scope of implementations may include any appropriate frequency range of operation, such as between 5 GHz and 13 GHz, or different, such as higher than 13 GHz, or lower than 2.3 GHz, such as sub −1 GHz frequencies.

In some embodiments, mixers 204 and 205 are current-mode mixers.

In some embodiments, mixer circuits 204 and 205 down convert their respective I and Q current mode signals to an intermediate frequency or baseband. Furthermore, each of the mixer circuits 204, 205 includes a differential current mode output.

In some embodiments, intermediate frequency amplifier (IFA) 206 receives the differential output from mixer circuit 204 at its inputs and provides a gain adjusted differential voltage output. For instance, resistor 207 is coupled from positive input to positive output of IFA 206, and resistor 208 is coupled from negative input to negative output of IFA 206. Each of resistors 207 and 208 may be implemented to be adjustable to change a level of gain provided by IFA 206. Furthermore, IFA 206 may include an analog filter to reduce unwanted frequencies from the intermediate frequency or baseband signal.

In some embodiments, IFA 209 is implemented similarly to IFA 206. For instance, resistors 210 and 211 may be implemented similarly to resistors 207 and 208 to provide adjustable gain. Furthermore, IFA 209 may provide analog filtering to reduce unwanted frequencies from the intermediate frequency or baseband signal.

In some embodiments, variable gain amplifier (VGA) 212 receives the gain adjusted differential c output of IFA 206 and provides an adjustable gain to the I signal. VGA 213 receives the gain adjusted differential output of IFA 209 and provides an adjustable gain to the Q signal. VGA 212 and VGA 213 may be implemented as operational amplifiers or other appropriate amplifier circuit architecture. VGA 212 generates a differential voltage output, which it provides to ADC 214. VGA 213 generates a differential voltage output, which it provides to ADC 215. ADCs 214, 215 convert the respective I and Q signals from analog-to-digital and provide respective digital outputs the digital processing circuit 110.

In some embodiments, receive AGC circuit 120 may control adjustable gain of the various components of system 200. For instance, receive AGC circuit 120 may provide control signals to each of the LNA 201, TAs 202 and 203, adjustable capacitive attenuators 103 and 106, mixers 204 and 205, resistors 207-211, and VGAs 212 and 213.

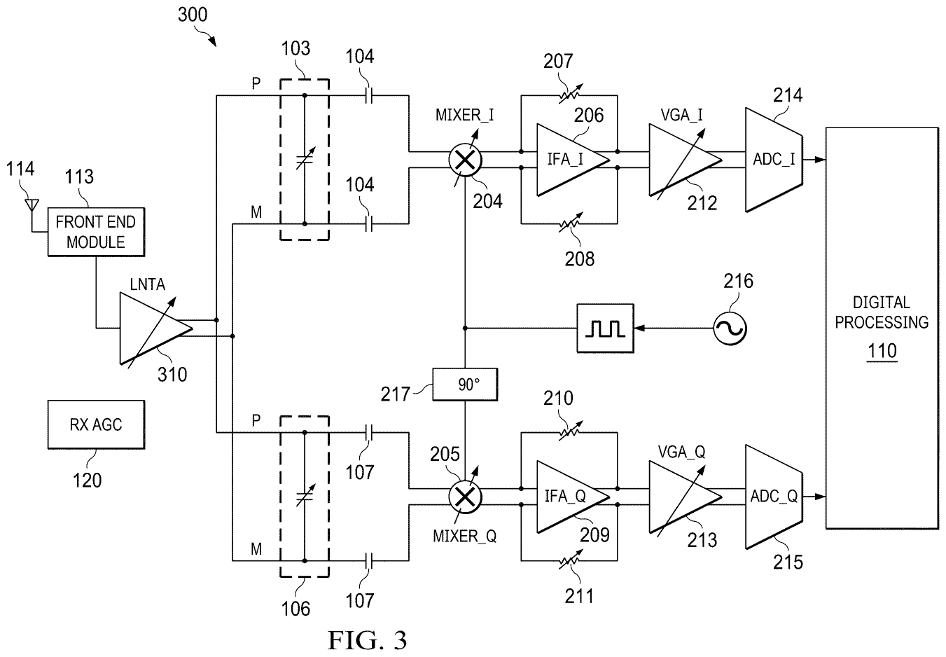

FIG. 3 is an illustration of example system 300, for receiving RF signals, according to some embodiments. System 300 may be implemented according to the concepts discussed above with respect to FIG. 1, though FIG. 3 omits illustrating a transmit signal chain for ease of illustration. System 300 is similar to system 200 of FIG. 2, but instead of using an LNA and TAs, system 300 employs LNTA 310 to provide a current mode differential RF signal to the mixers 204 and 205.

LNTA 310 is configured to receive a single-ended RF signal from antenna 114, via front end module 113. LNTA 310 may then provide an adjustable gain and convert the single-ended voltage to a differential current mode output. In this example, LNTA 310 does not include a tank circuit (e.g., tank circuit 218) at its differential output terminals (or as part of the LNTA 310). An example of an LNTA architecture that may be used for LNTA 310 is described in United States Patent Applications entitled, “CIRCUIT HAVING MULTIPLE CASCODE AMPLIFIERS AND CONTROLLABLE COMPONENTS,” associated with attorney docket T105611US01, and “CIRCUIT HAVING MULTIPLE CASCODE AMPLIFIERS,” associated with attorney docket T105917US01 filed on same day herewith and incorporated by reference herein.

The differential output of LNTA 310 is split so that a positive and negative conductor are coupled to the input of mixer circuit 204, and a positive and negative conductor are coupled to the input of mixer circuit 205.

The adjustable capacitive attenuators 103 and 106 are implemented between the positive and negative conductors at the input of mixer circuit 204 and mixer circuit 205 respectively. Similarly, the coupling capacitors 104 couple mixer circuit 204 to the differential output terminals of LNTA 310, and the coupling capacitors 107 couple mixer circuit 205 to the differential output terminals of LNTA 310.

Mixer circuits 204 and 205, IFAs 206 and 209, VGAs 212 and 213, and ADCs 214 and 215 may be implemented similarly as discussed above with respect to FIG. 2.

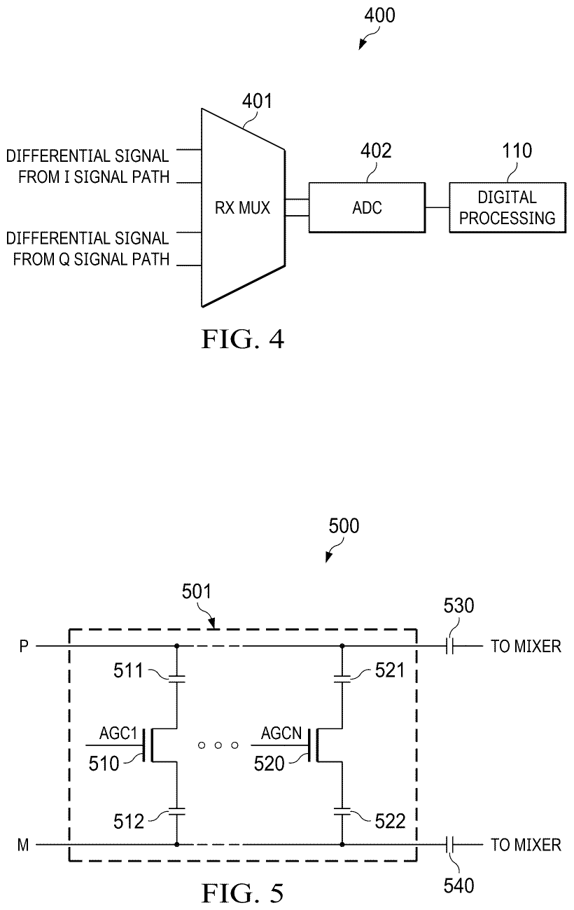

While FIGS. 2 and 3 illustrate ADC 214 implemented within the I signal path and ADC 215 implemented within the Q signal path, various embodiments may share ADC resources (e.g., a single ADC) between the I and Q signal paths. FIG. 4 illustrates example ADC resources 400, which may be used in receivers, such as those discussed above with respect to FIGS. 1-3.

Receive multiplexer 401 includes a first input for a differential signal from the I signal path, such as from the output of VGA 212 and includes a second input from the Q signal path, such as from the output of VGA 213. Multiplexer 401 may be controlled to provide time division multiplexing, so that at some times multiplexer 401 outputs the differential current mode signal from the I signal path and at other times it outputs the differential current mode signal from the queue path.

ADC 402 receives the output of multiplexer 401 at its inputs. Thus, ADC 402 receives only one of the differential current mode signals I or Q at a given time. ADC 402 in some examples may be implemented as a single ADC circuit, such as one of ADC 214 or 215. ADC 402 converts the signal at its input to a digital signal at its output. ADC 402 provides the output digital signal to the digital processing circuit 110.

System 100 of FIG. 1 may be adapted to use the architecture of ADC resources 400 by outputting an analog current mode I signal and an analog current mode Q signal from respective signal chains 105 and 108 to a multiplexer, such as multiplexer 402. System 200 of FIG. 2 may be adapted by omitting ADCs 214 and 215 and, instead, applying the outputs of VGAs 212 and 213 to a multiplexer, such as multiplexer 401 of FIG. 4. System 300 of FIG. 3 may be adapted similarly.

FIG. 5 is an illustration of an example adjustable capacitive attenuator circuit architecture 500, according to some embodiments. The adjustable capacitive attenuator circuits 103 and 106 of FIGS. 1-3 may be implemented according to the architecture 500 shown in FIG. 5 in some embodiments.

In the example of FIG. 5, capacitors 530 and 540 are coupling capacitors, and they may correspond to the set of coupling capacitors 104 and 107. For instance, coupling capacitors 530 and 540 are implemented between the output of the adjustable capacitive attenuator circuit 501 and the differential current mode inputs to a mixer (e.g., mixer circuit 204 or 205). Put another way, coupling capacitor 530 has a first terminal coupled to the output of adjustable capacitive attenuator circuit 501 and a second terminal coupled to a first input of the mixer. Similarly, coupling capacitor 540 has a first terminal coupled to the output of adjustable capacitive attenuator circuit 501 and a second terminal coupled to a second input of the mixer.

Adjustable capacitive attenuator circuit 501 includes multiple legs (N) coupled between the positive and negative output terminals of the input amplifier circuit. In this example, N may be an appropriate positive integer. A first leg includes a first capacitor 511, a second capacitor 512, and a transistor 510. Transistor 510 may be controlled by a signal AGC1 from the receive AGC circuit 120. When transistor 510 conducts current, it conducts current between the positive and negative input terminals of the input amplifier, thereby providing attenuation.

The Nth leg includes first capacitor 521, second capacitor 522, and transistor 520, which is controlled by control signal AGCN. When transistor 520 conducts current, it conducts current between the positive and negative input terminals of the input amplifier, the same as with the first leg described above.

In the example illustrated in FIG. 5, increased capacitance increases attenuation, and decreased capacitance decreases attenuation. In some examples, the sizes of the capacitors 511, 512, 521, and 522 may be selected so when the first leg is turned on, and no other leg is turned on, that causes a 6 dB reduction in gain, and each additional leg, when turned on reduces the gain by another 6 dB. For instance, when the first leg only is turned on, adjustable capacitive attenuator circuit 501 may reduce gain by 6 dB, and additionally turning on a second leg may provide a total gain reduction of 12 dB, and additionally turning on a third leg may provide a total gain reduction of 18 dB, and so on. However, the capacitance provided by the individual capacitors 511, 512, 521, and 522 may be selected according to any appropriate criteria to provide any desired gain steps.

The example above may be implemented by employing digital control signals from receive AGC circuit 120. Thus, the digital control signals would turn a given transistor (e.g., transistor 510 and transistor 520) either on or off. By contrast, another example implementation may use analog control signals at the control terminals of transistors 510-520. The analog control signals may be configured to provide any appropriate transistor operation, such as on (saturation region), off (cut off region), or linear region operation. In a linear region of operation, a transistor (e.g., transistor 510) may conduct some current, though less than it would in its saturation region. However, operation in the linear region may include greater impedance, attributable to the transistor, than would be expected in the saturation region of operation. The receive AGC circuit 120 may be configured appropriately to apply control signals AGC1-AGCN to provide a desired amount of attenuation.

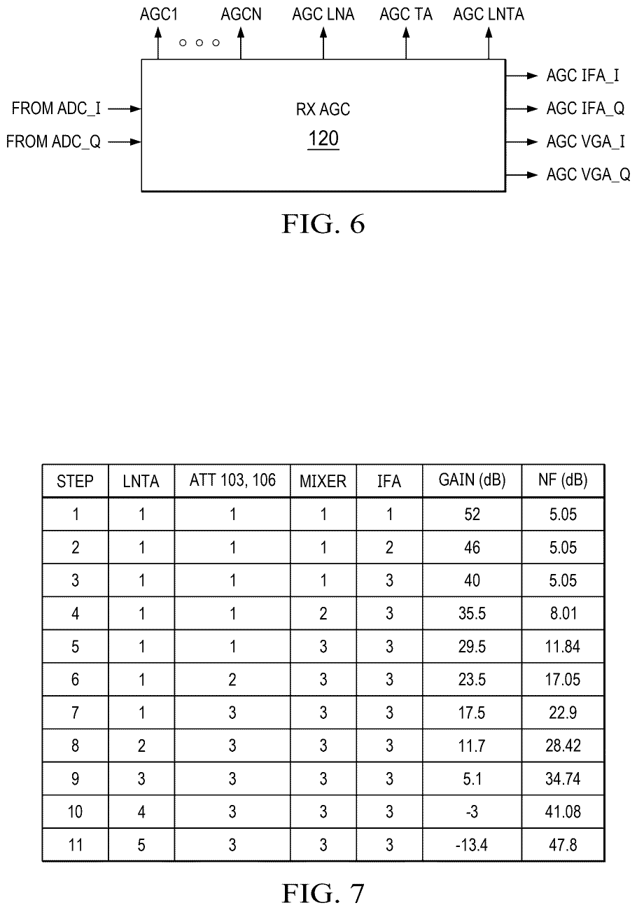

FIG. 6 is an illustration of receive AGC circuit 120, according to some embodiments. Specifically, receive AGC circuit 120 of FIG. 6 is configured to provide appropriate control signals to the various components of systems 100, 200, and/or 300 to control gain across both the I signal path and the Q signal path.

In one example, receive AGC circuit 120 may measure a signal level at the ADCs 214 and 215, as illustrated by the input signals from ADC_I and from ADC_Q. The receive AGC circuit 120 may measure the gain using any appropriate technique, such as measuring an amplitude of current or voltage at the input of the ADC, measuring a signal swing at the input of the ADC, measuring a signal swing at the output of the ADC, receiving digital measurements from the ADC itself, and/or the like. In any event, measuring the signal provides a representation of the total gain provided by the signal path and its various components.

In response to the signal measurements, receive AGC circuit 120 may provide control signals to control gain. For instance, the signals AGC VGA_I and AGC VGA_Q may be used to control gain at VGAs 212 and 213. The signals AGC IFA_I and AGC IFA_Q may be used to control gain at the IFAs 206 and 209, such as by adjusting the resistors 207, 208, 210, and 211. In another example, the receive AGC circuit 120 may use the signals AGC IFA_I and AGC IFA_Q to adjust a filtering property of IFAs 206 and 209 as appropriate. The signal AGC LNTA may be used to adjust a gain at LNTA 301, such as described in United States Patent Application entitled, “CIRCUIT HAVING MULTIPLE CASCODE AMPLIFIERS AND CONTROLLABLE COMPONENTS,” associated with attorney docket T105611US01. The signals AGC TA and AGC LNA may be used to adjust respective gain levels at TAs 202 and 203 and LNA 201. The signals AGC1-AGCN may be used to adjust gain levels at one or more of the adjustable capacitive attenuator circuits (e.g., 103 and 106).

FIG. 7 is an illustration of an example configuration for operation of receive AGC circuit 120, according to some embodiments. The column labeled Step lists 11 gain steps. Each row in the table corresponds to a single one of those gain steps. The column labeled LNTA illustrates gain step settings for LNTA 301, the column labeled ATT 103, 106 illustrates gain step settings for the adjustable capacitive attenuator circuits 103 and 106, the column labeled MIXER illustrates gain step settings for the mixers 204, 205, and the column labeled IFA illustrates gain step settings for the IFAs 206 and 209. Various embodiments may include more or fewer columns corresponding to more or fewer components that may be adjusted.

The column labeled GAIN corresponds to a measured level of gain for that particular gain step at a particular time. For instance, receive AGC circuit 120 may measure 52 dB of gain at gain step 1. The column labeled NF represents the noise figure for the I and Q signal paths collectively for a particular gain step at a particular time. The gain steps may be implemented by the receive AGC circuit 120 in order in this example, so that the receive AGC circuit 120 may implement gain step 1 first, gain step 2 second, and on and on as appropriate to reduce gain, where gain step 11 is the last available gain step. Of course, other embodiments may have more or fewer gain steps as appropriate. Also, the specific numbers given for gain in the gain column and for the noise figure in the NF column are for example, and other embodiments may be adapted for use with different levels of gain and noise figure.

With each increasing gain step, the gain measured at the ADC by the receive AGC circuit 120, decreases and the noise figure increases. Of course, the specific numbers for gain and noise figure are for illustration only, and the scope of implementations may include any receiver or transceiver that provides any appropriate level of gain and has any appropriate quantity of gain steps.

The IFA has three different gain step settings that are available for the receive AGC circuit 120 to adjust. Starting out at gain step 1, each of the different components are at their respective gain step settings 1, which corresponds to a highest amount of gain and a lowest amount of attenuation available in the receive signal paths.

If 52 dB of gain causes saturation, then the receive AGC circuit 120 may reduce the gain by moving from gain step 1 to gain step 2. The receive AGC circuit 120 may implement gain step 2 by adjusting the gain steps setting of the IFA for gain step setting 2. If 46 dB of gain is still too high, then the receive AGC circuit 120 may move from gain step 2 to gain step 3 by further adjusting the gain of the IFA down by going to gain step setting 3. Note that the other components—the mixer, the adjustable capacitive attenuators, and the LNTA—are still at their gain step settings 1.

In this particular example, only after having exhausted the gain step settings of the most downstream adjustable component (e.g., the IFAs), does the receive AGC circuit 120 move to a next most downstream component (e.g., the mixers). In this example, exhausting a gain step setting for a component may refer to reducing the gain of that component to a lowest available gain step setting or increasing an amount of attenuation of that component to a highest available gain step setting.

After having exhausted the gain step settings of the IFAs, the receive AGC circuit 120 may then move to the mixers by transitioning the system to gain step 4. In this example, the mixers are the next most upstream component from the IFAs. In this example, the mixers also have three available gain step settings, which may be adjusted at gain steps 4 and 5. If 29.5 dB of gain at gain step 5 still causes saturation, then the receive AGC circuit 120 may move to gain step 6 by adjusting the gain step settings of the adjustable capacitive attenuator circuits. In this example, the adjustable capacitive attenuator circuits are the next most upstream components from the mixers.

In one example, the adjustable capacitive attenuator circuit 501 may provide three different gain step settings. A first gain step setting, corresponding to gain steps 1-5, may include no legs being on. In the example of FIG. 5, the transistors 510 and 520 would both be off. A second gain step setting, corresponding to gain step 6, may include turning a single leg on, such as by turning transistor 510 on but leaving transistor 520 off. A third gain step setting, corresponding to gain step 7, may include additionally turning on another leg, such as by turning on transistor 520 while transistor 510 is still on. In this example, two legs provides three different gain step settings, corresponding to gain steps 5-7.

Once the gain settings of the adjustable capacitive attenuator circuit have been exhausted, such as by having increased attenuation to a maximum allowed level, the receive AGC circuit 120 may move to the LNTA, which is the most upstream component in the system 300. The receive AGC circuit 120 may reduce the gain using the five different gain step settings provided by the LNTA in this example. The last gain step setting, 11, corresponds to each of the components providing their minimum allowed gain (or maximum allowed attenuation) and provides −13.4 dB of gain.

Of course, in various embodiments, the receive AGC circuit 120 may not use all of the available gain steps. For instance, the receive AGC circuit 120 may determine that 23.5 dB of gain is a highest available gain without causing undesired saturation or other undesired distortion and, thus, the receive AGC circuit 120 may leave the system at gain step 6. However, a strength of a received signal, such as caused by movement of a device, changes in the air medium, and the like, may change, and the receive AGC circuit 120 may transition from one gain step to another gain step as appropriate.

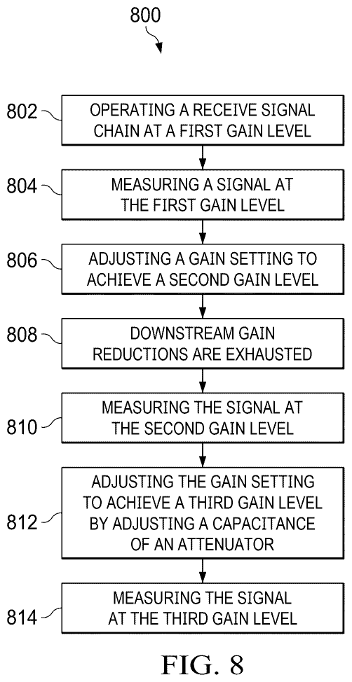

FIG. 8 is an illustration of an example method 800, for adjusting a gain in a circuit, according to some embodiments. In some examples, method 800 may be performed by receive AGC circuit 120 to adjust the gain in receiver and/or transceiver systems, such as those illustrated in FIGS. 1-3. The functionality in method 800 may be implemented using hardware logic in the receive AGC circuit 120. Additionally or alternatively, the functionality of method 800 may be implemented by receive AGC circuit 120 including a processor core that executes computer-readable instructions to cause receive AGC circuit 120 to perform the actions of method 800.

Action 802 includes operating a receive signal chain at a first gain level. Example receive signal chains are illustrated in FIG. 1 as receive signal chains 105 and 108. Example receive signal chains are also illustrated in FIGS. 2-3 as including mixers, amplifiers, ADCs, and the like. In various embodiments, components of the signal chains may have adjustable gain step settings that provide a gain step, such as discussed above with respect to FIG. 7. The first gain level of action 802 may correspond to an example gain step of FIG. 7.

Action 804 includes measuring a signal at the first gain level. As discussed above with respect to FIG. 6, the receive AGC circuit 120 may measure the signal at an ADC. However, the scope of implementations is not limited to only measuring the signal at an ADC, as the signal may be measured at any appropriate point in the receive signal chain. In some examples, measuring the signal may include measuring a current level, a voltage level, a voltage swing, digital data indicating an amplitude associated with the signal, and/or the like.

Action 806 includes adjusting a gain setting to achieve a second gain level. For instance, the measured signal at action 804 may be above a pre-programmed or pre-defined threshold, associated with saturation or other distortion. In response, the receive AGC circuit 120 may be configured to reduce a gain step of the receive signal chain to achieve a second gain level. Example gain steps are discussed above with respect to FIG. 7.

At action 808, the downstream gain reductions are exhausted. For instance, the receive AGC circuit 120 may be configured to reduce gain one step at a time, and performed on downstream components first and then only moving upstream to other components after downstream gain reductions have been exhausted. In the example of FIG. 3, this may be accomplished by reducing gain step settings at the VGA 212 first and, only after gain reduction has been exhausted at VGA 212, then beginning to reduce gain step settings at IFA 206, then only after gain reduction has been exhausted at IFA 206, then beginning reducing gain step settings at mixer circuit 204. This may be continued component-by-component from downstream to upstream, adjusting the capacitive attenuator circuit 103 only after having exhausted gain reduction at mixer circuit 204, then moving to LNTA 310 to adjust its gain settings only after having exhausted gain reduction at adjustable capacitive attenuator circuit 103.

Of course, that is just one example, and the scope of implementations may be adapted for use in receive signal chains that have different components, have fewer components, have additional components, or have components that are rearranged from those discussed above with respect to FIGS. 1-3.

At action 810, the receive AGC circuit 120 may measure the signal again, such as described above with respect to step 804.

At action 812, the receive AGC circuit 120 may adjust the gain setting again to achieve the third gain level by adjusting a capacitance of an attenuator. For instance, once it is appropriate to begin reducing gain at an adjustable capacitive attenuator circuit (e.g., circuit 103), then the receive AGC circuit 120 may use control signals to increase attenuation at the adjustable capacitive attenuator circuit. As described above with respect to FIG. 5, increasing attenuation may include turning an additional transistor on (e.g., using digital control signals) or adjusting operation in a linear operating region (e.g., using analog control signals).

Examples of adjusting gain settings by adjusting the capacitance of an attenuator are further discussed above with respect to gain steps 6 and 7 of FIG. 7.

Action 814 includes measuring the signal at the third gain level, which may be performed the same as or similar to the measurement described above with respect to action 804.

Although not illustrated in FIG. 8, method 800 may include additional steps, such as performing further adjustments after the measurement of action 814. Additionally, method 800 may further include adjusting a gain up based on measuring the signal. For instance, as signal conditions change, the receive AGC circuit 120 may determine that the signal level is below a pre-programmed or pre-defined threshold and may be configured to increase gain in response. In one example, the receive AGC circuit 120 may then increase gain going from downstream components first and if appropriate moving upstream component-by-component.

Further, while method 800 is discussed above with respect to a single receive signal chain, the scope of implementations may include adjusting gain in at least one additional receive signal chain. For instance, receive AGC circuit 120 may be configured to make the same gain adjustments at a time at both the I and Q signal paths in example systems, such as those illustrated in FIGS. 1-3.

Example embodiments of the present disclosure are summarized here. Other embodiments can also be understood from the entirety of the specification and the claims filed herein.

Example 1. An electronic circuit including: a first signal path including: a first current mode mixer having first and second inputs, and first and second outputs; a first amplifier circuit having first and second inputs respectively coupled to the first and second outputs of the first current mode mixer; and a first adjustable capacitive attenuator circuit having first and second outputs respectively coupled to the first and second inputs of the first current mode mixer; and a second signal path including: a second current mode mixer having first and second inputs, and first and second outputs; a second amplifier circuit having first and second inputs respectively coupled to the first and second outputs of the second current mode mixer; and a second adjustable capacitive attenuator circuit having first and second outputs respectively coupled to the first and second inputs of the second current mode mixer.

Example 2. The electronic circuit of example 1, further including a phase-locked-loop (PLL) having an output coupled to a clock input of the first current mode mixer, and to a clock input of the second current mode mixer.

Example 3. The electronic circuit of one of examples 1 or 2, further including a 90 degrees phase-shifting circuit coupled between the output of the PLL and the second current mode mixer.

Example 4. The electronic circuit of one of examples 1 to 3, where the first amplifier circuit includes a first filter coupled to a first variable gain amplifier, and where the second amplifier circuit includes a second filter coupled to a second variable gain amplifier.

Example 5. The electronic circuit of one of examples 1 to 4, where the first signal path includes a first analog-to-digital converter (ADC) having an input coupled to first output of the first current mode mixer, and where the second signal path includes a second ADC having an input coupled to the first output of the second current mode mixer.

Example 6. The electronic circuit of one of examples 1 to 5, further including an input amplifier circuit including a differential output having first and second outputs respectively coupled to the first and second inputs of the first adjustable capacitive attenuator circuit.

Example 7. The electronic circuit of one of examples 1 to 6, where the input amplifier circuit includes a low-noise amplifier (LNA).

Example 8. The electronic circuit of one of examples 1 to 7, where the input amplifier circuit includes a transconductance amplifier (TA) having first and second inputs respectively coupled to first and second outputs of the LNA, and first and second outputs respectively coupled to the first and second inputs of the first adjustable capacitive attenuator circuit.

Example 9. The electronic circuit of one of examples 1 to 8, further including a tank filter coupled to an output of the LNA.

Example 10. The electronic circuit of one of examples 1 to 9, where the input amplifier circuit includes a low noise transconductance amplifier (LNTA) having first and second outputs respectively coupled to the first and second inputs of the first adjustable capacitive attenuator circuit.

Example 11. The electronic circuit of one of examples 1 to 10, further including an antenna coupled to an input of the input amplifier circuit.

Example 12. The electronic circuit of one of examples 1 to 11, where the first capacitive attenuator circuit includes: a first leg having a first capacitor and a first transistor coupled between the first and second inputs of the first adjustable capacitive attenuator circuit; and a second leg having a second capacitor and a second transistor coupled between the first and second inputs of the first adjustable capacitive attenuator circuit.

Example 13. The electronic circuit of one of examples 1 to 12, further including a gain control circuit coupled to the first and second transistors.

Example 14. The electronic circuit of one of examples 1 to 13, where the gain control circuit is configured to control on and off states of the first transistor and the second transistor by applying a digital one or a digital 0 to control terminals of the first transistor and the second transistor.

Example 15. The electronic circuit of one of examples 1 to 14, where the gain control circuit is configured to control the first transistor and the second transistor within a linear region of operation by applying analog signals to control terminals of the first transistor and the second transistor.

Example 16. The electronic circuit of one of examples 1 to 15, where the first signal path includes an in-phase signal path, and where the second signal path includes a quadrature-phase signal path.

Example 17. The electronic circuit of one of examples 1 to 16, where the first adjustable capacitive attenuator circuit includes: a first capacitor coupled between the first output of the first adjustable capacitive attenuator and the first input of the first current mode mixer; and a second capacitor coupled between the second output of the first adjustable capacitive attenuator and the second input of the first current mode mixer.

Example 18. The electronic circuit of one of examples 1 to 17, where the second adjustable capacitive attenuator circuit includes: a third capacitor coupled between the first output of the second adjustable capacitive attenuator and the first input of the second current mode mixer; and a fourth capacitor coupled between the second output of the second adjustable capacitive attenuator and the second input of the second current mode mixer.

Example 19. The electronic circuit of one of examples 1 to 18, where the first signal path includes a first analog-to-digital converter having an input coupled to an output of the first amplifier circuit, where the second signal path includes a second analog-to-digital converter having an input coupled to an output of the second amplifier circuit.

Example 20. The electronic circuit of one of examples 1 to 19, further including: a multiplexer having a first input coupled to an output of the first signal path, a second input coupled to an output of the second signal path, and an output; and an analog-to-digital converter having an input coupled to the output of the multiplexer.

Example 21. The electronic circuit of one of examples 1 to 20, further including: an analog-to-digital converter (ADC) having an input coupled to the first signal path; and a gain control circuit configured to: measure a signal at the input of the ADC or at an output of the ADC; and adjust a capacitance of the first adjustable capacitive attenuator circuit based on the measured signal.

Example 22. The electronic circuit of one of examples 1 to 21, where, to adjust the capacitance of the first adjustable capacitive attenuator, the gain control circuit is configured to provide a first control signal to the first adjustable capacitive attenuator, where the gain control circuit is further configured to provide the first control signal to the second adjustable capacitive attenuator.

Example 23. The electronic circuit of one of examples 1 to 22, where the gain control circuit is configured to lower a gain of the first adjustable capacitive attenuator circuit after lowering a gain of the first amplifier circuit to a predetermined minimum gain.

Example 24. The electronic circuit of one of examples 1 to 23, further including a low noise trans-impedance amplifier (LNTA) having an input configured to receive a signal from an antenna, and an output coupled to an input of the first signal path, and to an input of the second signal path.

Example 25. The electronic circuit of one of examples 1 to 24, where the output of the LNTA is a differential output, where the first signal path includes a first pair of coupling capacitors coupled to the differential output of the LNTA and coupled to the first adjustable capacitive attenuator circuit, and where the first amplifier circuit includes: a first intermediate frequency amplifier having first and second inputs coupled to the first and second outputs of the first current mode mixer; a first variable gain amplifier having an input coupled to an output of the first intermediate frequency amplifier; and an analog-to-digital converter (ADC) having an input coupled to an output of the first variable gain amplifier.

Example 26. The electronic circuit of one of examples 1 to 25, where the second signal path includes a second pair of coupling capacitors coupled to the differential output of the LNTA and coupled to the second adjustable capacitive attenuator circuit, and where the second amplifier circuit includes: a second intermediate frequency amplifier having first and second inputs coupled to the first and second outputs of the second current mode mixer; and a second variable gain amplifier coupled to an output of the second intermediate frequency amplifier.

Example 27. The electronic circuit of one of examples 1 to 26, further including: a gain control circuit configured to measure a voltage swing at an input or output of the ADC, and lower a gain setting of the LTNA after a gain of the first adjustable attenuator circuit reaches a minimum gain.

Example 28. The electronic circuit of one of examples 1 to 27, where the electronic circuit does not include a tank filter coupled to an input of the first signal path.

Example 29. An electronic circuit including: an antenna terminal; a low noise trans-impedance amplifier (LNTA) having an input coupled to the antenna terminal, and first and second outputs; a current mode mixer having first and second inputs; and an adjustable capacitive attenuator having a first terminal coupled to the first output of the LNTA and to the first input of the current mode mixer, and a second terminal coupled to the second output of the LNTA and to the second input of the current mode mixer.

Example 30. The electronic circuit of example 29, where the adjustable capacitive attenuator includes first and second capacitors coupled between the first and second terminals of the adjustable capacitive attenuator, and a first transistor having a current path coupled between the first and second capacitors.

Example 31. The electronic circuit of one of examples 29 or 30, further including a gain control circuit having a first output coupled to a control terminal of the first transistor.

Example 32. The electronic circuit of one of examples 29 to 31, where the gain control circuit is configured to provide, at the first output of the gain control circuit, a control signal to operate the first transistor in a linear region.

Example 33. The electronic circuit of one of examples 29 to 32, where the gain control circuit is configured to provide, at the first output of the gain control circuit, a digital control signal.

Example 34. The electronic circuit of one of examples 29 to 33, where the adjustable capacitive attenuator further includes a second transistor coupled between the first and second terminals of the adjustable capacitive attenuator, and where the gain control circuit includes a second output coupled to a control terminal of the second transistor.

Example 35. The electronic circuit of one of examples 29 to 34, where the electronic circuit is implemented as an integrated circuit separate from the amplifier circuit.

Example 36. The electronic circuit of one of examples 29 to 35, where the adjustable capacitive attenuator and the mixer are implemented in an in-phase signal path, where the electronic circuit further includes a quadrature-phase signal path.

Example 37. A method including: operating a receive signal chain at a first gain level, where the receive signal chain includes a capacitive attenuator having first and second terminals respectively coupled to first and second inputs of a current mode mixer; adjusting a gain setting of the receive signal chain to a second gain level without adjusting a capacitance of the capacitive attenuator, where the second gain level is lower than the first gain level; measuring a signal at the second gain level; and in response to measuring the signal, adjusting the gain setting to a third gain level, which is lower than the second gain level, including adjusting the capacitance of the capacitive attenuator to achieve the third gain level, the third gain level being lower than the second gain level.

Example 38. The method of example 37, where measuring the signal includes measuring a voltage, and where adjusting the capacitance of the capacitive attenuator to achieve the third gain level includes adjusting the capacitance of the capacitive attenuator in response to the voltage being higher than a predetermined voltage.

Example 39. The method of one of examples 37 or 38, adjusting the gain setting to the third gain level includes adjusting the gain setting to the third gain level in response to the measured signal being higher than a predetermined threshold.

Example 40. The method of one of examples 37 to 39, where the capacitive attenuator includes: a first capacitor and a first transistor coupled between the first and second terminals of the capacitive attenuator; and a second capacitor and a second transistor coupled between the first and second terminals of the capacitive attenuator, where adjusting the capacitance of the capacitive attenuator includes changing a state of the first transistor from off to on to create a current path through the first capacitor.

Example 41. The method of one of examples 37 to 40, where the third gain level corresponds to the first transistor being on and the second transistor being off.

Example 42. The method of one of examples 37 to 41, further including: measuring the signal at the third gain level; and in response to measuring the signal at the third gain level, adjusting the gain setting to a fourth gain level, which is lower than the third gain level, including further adjusting the capacitance of the capacitive attenuator to achieve the fourth gain level.

Example 43. The method of one of examples 37 to 42, where the fourth gain level corresponds to the first transistor being on and the second transistor being on.

Example 44. The method of one of examples 37 to 43, where the second gain level corresponds to the first transistor being off and the second transistor being off.

Example 45. The method of one of examples 37 to 44, where the third gain level is a 6 dB reduction relative to the second gain level, and where the fourth gain level is a 6 dB reduction relative to the third gain level.

Example 46. The method of one of examples 37 to 45, where adjusting the gain setting of the receive signal chain to the second gain level includes: reducing a gain of a variable gain amplifier of the receive signal chain.

Example 47. The method of one of examples 37 to 46, where adjusting the gain setting of the receive signal chain to the second gain level includes: reducing a gain of an intermediate frequency amplifier of the receive signal chain.

Example 48. The method of one of examples 37 to 47, where adjusting the gain setting of the receive signal chain to the second gain level includes: reducing a gain of a mixer of the receive signal chain.

Example 49. The method of one of examples 37 to 48, where adjusting the gain setting of the receive signal chain to the second gain level includes: exhausting a gain reduction for devices of the receive signal chain downstream of the capacitive attenuator.

Example 50. The method of one of examples 37 to 49, where adjusting the capacitance of the capacitive attenuator to achieve the third gain level is performed only after exhausting a gain reduction for devices of the receive signal chain downstream of the capacitive attenuator.

Example 51. The method of one of examples 37 to 50, where adjusting the capacitance of the capacitive attenuator to achieve the third gain level is performed only after reducing a gain of the receive signal chain to a minimum gain setting for devices of the receive signal chain downstream of the attenuator.

Example 52. The method of one of examples 37 to 51, where adjusting the capacitance of the capacitive attenuator to achieve the third gain level includes increasing the capacitance of the capacitive attenuator.

Example 53. The method of one of examples 37 to 52, where the method is performed by an automatic gain control circuit of a transceiver.

Example 54. The method of one of examples 37 to 53, where adjusting the gain setting to the third gain level includes reducing an amount of current of the signal.

Example 55. The method of one of examples 37 to 54, where the capacitive attenuator includes a capacitor and a transistor coupled between the first and second terminals of the capacitive attenuator, where adjusting the capacitance of the capacitive attenuator includes adjusting operation of the transistor within a linear range of the transistor.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. An electronic circuit comprising:
a first signal path comprising:
a first current mode mixer having first and second inputs, and first and second outputs;
a first amplifier circuit having first and second inputs respectively coupled to the first and second outputs of the first current mode mixer; and
a first adjustable capacitive attenuator circuit having first and second outputs respectively coupled to the first and second inputs of the first current mode mixer; and
a second signal path comprising:
a second current mode mixer having first and second inputs, and first and second outputs;
a second amplifier circuit having first and second inputs respectively coupled to the first and second outputs of the second current mode mixer; and
a second adjustable capacitive attenuator circuit having first and second outputs respectively coupled to the first and second inputs of the second current mode mixer.

2. The electronic circuit of claim 1, further comprising:
a phase-locked-loop (PLL) having an output coupled to a clock input of the first current mode mixer, and to a clock input of the second current mode mixer; and
a 90 degrees phase-shifting circuit coupled between the output of the PLL and the second current mode mixer.

3. The electronic circuit of claim 1, wherein the first amplifier circuit comprises a first filter coupled to a first variable gain amplifier, and wherein the second amplifier circuit comprises a second filter coupled to a second variable gain amplifier.

4. The electronic circuit of claim 1, wherein the first signal path comprises a first analog-to-digital converter (ADC) having an input coupled to first output of the first current mode mixer, and wherein the second signal path comprises a second ADC having an input coupled to the first output of the second current mode mixer.

5. The electronic circuit of claim 1, further comprising an input amplifier circuit comprising a differential output having first and second outputs respectively coupled to the first and second inputs of the first adjustable capacitive attenuator circuit.

6. The electronic circuit of claim 5, wherein the input amplifier circuit comprises a low-noise amplifier (LNA).

7. The electronic circuit of claim 6, wherein the input amplifier circuit comprises a transconductance amplifier (TA) having first and second inputs respectively coupled to first and second outputs of the LNA, and first and second outputs respectively coupled to the first and second inputs of the first adjustable capacitive attenuator circuit; and
wherein the electronic circuit further comprises a tank filter coupled to an output of the LNA.

8. The electronic circuit of claim 5, further comprising an antenna coupled to an input of the input amplifier circuit.

9. The electronic circuit of claim 5, wherein the first capacitive attenuator circuit comprises:
a first leg having a first capacitor and a first transistor coupled between the first and second inputs of the first adjustable capacitive attenuator circuit; and
a second leg having a second capacitor and a second transistor coupled between the first and second inputs of the first adjustable capacitive attenuator circuit.

10. The electronic circuit of claim 1, further comprising a gain control circuit coupled to the first and second transistors, wherein the gain control circuit is configured to control on and off states of the first transistor and the second transistor by applying a digital one or a digital 0 to control terminals of the first transistor and the second transistor.

11. The electronic circuit of claim 10, wherein the gain control circuit is configured to control the first transistor and the second transistor within a linear region of operation by applying analog signals to control terminals of the first transistor and the second transistor.

12. The electronic circuit of claim 1, wherein the first signal path comprises an in-phase signal path, and wherein the second signal path comprises a quadrature-phase signal path.

13. The electronic circuit of claim 1, wherein the first adjustable capacitive attenuator circuit comprises:
a first capacitor coupled between the first output of the first adjustable capacitive attenuator and the first input of the first current mode mixer; and
a second capacitor coupled between the second output of the first adjustable capacitive attenuator and the second input of the first current mode mixer.

14. The electronic circuit of claim 13, wherein the second adjustable capacitive attenuator circuit comprises:
a third capacitor coupled between the first output of the second adjustable capacitive attenuator and the first input of the second current mode mixer; and
a fourth capacitor coupled between the second output of the second adjustable capacitive attenuator and the second input of the second current mode mixer.

15. The electronic circuit of claim 1, wherein the first signal path comprises a first analog-to-digital converter having an input coupled to an output of the first amplifier circuit, wherein the second signal path comprises a second analog-to-digital converter having an input coupled to an output of the second amplifier circuit.

16. The electronic circuit of claim 1, further comprising:
a multiplexer having a first input coupled to an output of the first signal path, a second input coupled to an output of the second signal path, and an output; and
an analog-to-digital converter having an input coupled to the output of the multiplexer.

17. The electronic circuit of claim 1, further comprising:
an analog-to-digital converter (ADC) having an input coupled to the first signal path; and
a gain control circuit configured to:
measure a signal at the input of the ADC or at an output of the ADC; and
adjust a capacitance of the first adjustable capacitive attenuator circuit based on the measured signal.

18. The electronic circuit of claim 17, wherein, to adjust the capacitance of the first adjustable capacitive attenuator, the gain control circuit is configured to provide a first control signal to the first adjustable capacitive attenuator, wherein the gain control circuit is further configured to provide the first control signal to the second adjustable capacitive attenuator.

19. The electronic circuit of claim 17, wherein the gain control circuit is configured to lower a gain of the first adjustable capacitive attenuator circuit after lowering a gain of the first amplifier circuit to a predetermined minimum gain.

20. The electronic circuit of claim 1, further comprising a low noise trans-impedance amplifier (LNTA) having an input configured to receive a signal from an antenna, and an output coupled to an input of the first signal path, and to an input of the second signal path, wherein the output of the LNTA is a differential output, wherein the first signal path comprises a first pair of coupling capacitors coupled to the differential output of the LNTA and coupled to the first adjustable capacitive attenuator circuit, and further wherein the first amplifier circuit comprises:
a first intermediate frequency amplifier having first and second inputs coupled to the first and second outputs of the first current mode mixer;
a first variable gain amplifier having an input coupled to an output of the first intermediate frequency amplifier; and
an analog-to-digital converter (ADC) having an input coupled to an output of the first variable gain amplifier.

21. The electronic circuit of claim 20, wherein the second signal path comprises a second pair of coupling capacitors coupled to the differential output of the LNTA and coupled to the second adjustable capacitive attenuator circuit, and wherein the second amplifier circuit comprises:
a second intermediate frequency amplifier having first and second inputs coupled to the first and second outputs of the second current mode mixer; and
a second variable gain amplifier coupled to an output of the second intermediate frequency amplifier.

22. The electronic circuit of claim 1, wherein the electronic circuit does not include a tank filter coupled to an input of the first signal path.
